(19) United States
(12) Patent Application Publication
(10) Pub. No.: US 2018/0108496 A1
(43) Pub. Date: Apr. 19, 2018

(54) Method of Assembly of Electrochemical Cells for High Temperature Applications

(71) Applicants: Sagar Venkateswaran, Glen Mills, PA (US); Franciscus X. Pratiktohadi, Philadelphia, PA (US)

(72) Inventors: Sagar Venkateswaran, Glen Mills, PA (US); Franciscus X. Pratiktohadi, Philadelphia, PA (US)

(21) Appl. No.: 15/330,629

(22) Filed: Oct. 19, 2016

(51) Int. Cl. H01G 11/86; H01M 10/0525; H01M 10/0585; H01M 10/04; H01M 2/08; H01M 4/04; B23K 11/00; B23K 26/22; B23K 20/10; H01G 11/78; H01G 11/74; H01G 11/66; H01G 11/52; H01G 11/24; H01G 11/58

(52) U.S. Cl. CPC H01G 11/86; B23K 2203/08; H01M 10/0585; H01M 10/0468; H01M 2/08; H01M 4/0416; H01M 4/0409; H01M 4/0411; B23K 11/002; B23K 26/22; B23K 20/10; H01G 11/78; H01G 11/74; H01G 11/66; H01G 11/52; H01G 11/24; H01G 11/58; H01M 10/0525

(57) ABSTRACT

Heat resistant, highly conductive electrochemical cells for high temperature applications and methods of their assembly are described herein. The cells have at least two electrodes and at least one separator enclosed in heat resistant ceramic enclosure with metalized terminals on its bottom. Methods of the electrodes' tabs welding to inside connectors and the electrodes' coating are also disclosed. The resulting cells are solderable to circuit boards or various circuits.

### CROSS REFERENCE TO RELATED DOCUMENTS

This Application is a continuation in part of the Application of Sagar Venkateswaran and Franciscus X. Pratiktohadi Ser. No. 15,330,120 filed on Aug. 10, 2016, and entitled “Electrochemical Cells Construction and Packaging for High Temperature Applications”.

### BACKGROUND OF THE INVENTION

### Field of the Invention

This invention pertains to electrochemical devices, such as ultracapacitors and lithium battery cells, for high temperature processing and applications.

### Description of Prior Art

Prior art high temperature electrochemical cells, such as ultracapacitors and lithium battery cells, are used mostly as a memory back up power of semiconductors, and are usually enclosed in a metal casing of a coin shape, having two shells crimped together with an insulating gasket there between. Each shell is in contact with one electrode. The cells are activated by non-aqueous, high temperature electrolyte before crimping. However, these cells are too large for today's printed circuit boards with micro components being soldered to them by wave soldering method, which requires passing the printed board with the micro-components like ultracapacitors through a furnace at high temperature to melt the solder (like 200-230° C.), and they need to have terminals added, which is expensive.

This problem was partially addressed by Shunji Watanabe's U.S. Pat. No. 6,445,566. Watanabe teaches ultracapacitor micro-cell, placed in a ceramic square shaped housing pan with metalized inside surface as a collector, connected with a metalized positive terminal on the bottom outside surface. The housing pan has also a metalized rim all around the top, connected with a negative terminal on the bottom outside surface. The housing is closed by a solid metal lid collector in contact with the negative electrode and the rim.

Method of the prior art cell assembly is as follows: Due to the moisture sensitivity of the electrolyte/salts, the positive and negative electrodes with separator between them must be fabricated and stacked into the housing under inert atmosphere which is both difficult and expensive. Each electrode layer and the separator layer are already activated by and contain an electrolyte before assembly, which prevents a good conductive contacts of wet electrodes with the collectors, and thus has a poor conductivity. This Patent describes only one cell stacked into this housing design, because the electrodes do not have individual collectors with tabs. The metal lid is electrically connected and sealed to the metalized rim all around by brazing, which is expensive and cumbersome, and may thus create an imperfect seal.

Also, the brazing solder melting temperature is higher than the electrolyte boiling point temperature, which may damage the electrolyte and thus cause the cell failure.

Instant invention overcomes the disadvantages of the prior art and provides design and methods for easy making and assembling of electrodes and cells in air, and such cells like heat resistant ultracapacitors, asymmetric capacitors, and/or lithium-ion cells have a low resistance.

### SUMMARY OF THE INVENTION

Now it has been found, that much easier construction and methods of assembly of heat resistant micro-cells having high conductivity can be made by coating the cells electrode's materials with water based binder, in air, on pretreated aluminum or copper micro-grids' collectors without an electrolyte in the coating. The housing of the cell may be similar to the housing of Watanabe, and may have the metalized inside bottom and the top rim, and the metal lid. The electrodes of the invention are different and have long terminal tabs as an extension of the grid collectors.

The method of the cell assembly is as follows:

The long terminal tab of the positive electrode is resistance or ultrasound welded in air to the metalized bottom inside surface of the housing pan, while the electrode is kept outside, and the electrode is then folded on top of the terminal tab. The long terminal tab of the negative electrode is resistance or ultrasound welded in air to the metal lid, and is folded later on top of the electrode. A dry, heat resistant porous separator is placed in the air between the electrodes, and the lid is kept open. Because the whole assembled cell inside is porous due to the use of the grid collectors, the opened cell is dried under vacuum, and activated by liquid, non-aqueous, high temperature electrolyte in an inert dry atmosphere, and the lid is closed and impermeably sealed by high temperature epoxy adhesive to the rim. The metal lid is then additionally secured by several laser metal tack welds, preferably at the corners of the lid, which provides electrical bridge bead contacts to the rim and thus to the negative terminal.

The improvement is in the welded contacts of the metal terminal tabs of the electrodes to the metalized conductors, and in the coated electrodes on micro-grid current collectors. This construction provides stronger and more conductive joints between the electrodes and their terminals, and the assembly is made in air, which is much easier than in the inert atmosphere of the prior art.

Also, the epoxy joint of the lid to the rim does not heat the electrolyte and thus is not causing any damage. The laser welds also do not heat up the cell, as the brazing of the prior art does.

Method of assembly in more detail is as follows: When the cell is open and partially assembled, the positive electrode's tab is resistance or ultrasound welded to the inner bottom horizontal metalized layer of the housing. The positive electrode is positioned 90 degrees to the bottom layer and the tab is bent to provide a space for the welder rod. After the welding, the positive electrode is folded on top of the tab, and the separator is added. The negative electrode is inserted into the cell on top of the separator, is clamped and its long tab is left horizontally protruding out of the cell housing.

The lid is inserted under the protruding tab and the tab is resistance or ultrasound welded to the lid.

Then the tab with the lid is bent 90 degrees upward or more, and this still open cell is vacuum dried for several hours in a vacuum chamber. After drying, the cell is activated by a metered electrolyte from a syringe in an inert dry atmosphere glove box, the clamp is removed and the lid is sealed and adhesively attached to the rim by high temperature resistant adhesive like epoxy. After the adhesive is solidified, the sealed cell assembly is removed from the glove box and the lid is additionally secured in air by the electro-conductive laser weld metal beads to the rim.

An optional method of assembly comprises stacking the positive electrode, separator, and the negative electrode as a subassembly and clamping them together, then the positive electrode tab is similarly bent 90 degrees and welded to the bottom inside metalized layer. The cell subassembly is then folded on top of the positive electrode tab.

Then the lid is similarly welded to the negative electrode tab, and folded. It is apparent to a person skilled in the art, that several cells can be stacked into the housing and similarly connected by metal welding in parallel for higher capacity, while maintaining high rate capability, as compared to one thick cell. The continuous separator is preferably “Z” folded between the stacked electrodes and is larger than electrodes' active surface to prevent short-circuiting. The metalized connectors, rim and terminals outside are preferably made from selected metals including nickel, tungsten, silver and gold and the metalized bottom inside layer is preferably of aluminum. Because the bottom outside terminals are an integrated part of the receiving housing pan, no additional terminals welded to the housing are needed, which makes the cell more economical. Described cells are solderable to circuit boards and/or other circuits.

Method of assembly of the multi-cell is substantially similar to the method of assembly of the single cell.

The principal object of the invention is to provide non-aqueous, low cost and low impedance cells for high temperature applications.

Another object of the invention is to provide high temperature resistant ultra-capacitors and micro-batteries which are easy to assemble.

A further object of the invention is to provide high temperature micro-cells which are solderable.

A further object of the invention is to provide high temperature micro-cells which are solderable by wave soldering method and by heating the cells in an oven.

A further object of the invention is to provide high temperature micro-cells which can be mass produced by automation.

Other objects and advantages of the invention will be apparent from the description and appended claims.

### BRIEF DESCRIPTION OF THE DRAWINGS

The nature and characteristic features of the invention will be more readily understood from the following description taken in connection with the accompanying drawing forming part thereof, in which:

FIG. 1 illustrates sectional side view of high temperature resistant cell of the invention inside of high temperature resistant housing, showing their components.

FIG. 2 illustrates bottom view of high temperature resistant housing, having metalized terminals thereon, and electrodes with separator inside.

FIG. 3 illustrates sectional side view of typical electrode of the high temperature cell of the invention, having active materials coated on metal grid.

FIG. 4 illustrates top view of the electrode shown in FIG. 3.

FIG. 5 illustrates sectional side view of high temperature resistant multi-cell assembly inside of high temperature resistant housing, showing their components.

FIG. 6 illustrates sectional side view of high temperature resistant cell housing without the lid, while the positive electrode tab is being resistance or ultrasound welded to inside metalized bottom layer of the housing, and the positive electrode is being held 90 degrees upward.

FIG. 7 illustrates sectional side view of high temperature resistant cell open, while the negative electrode tab is being resistance or ultrasound welded to the lid.

FIG. 8 illustrates sectional side view of high temperature resistant cell housing without the lid, while the positive electrode tab is being resistance or ultrasound welded to inside metalized bottom layer of the housing, and the preassembled cell is being held 90 degrees upward.

It should, of course be understood that the description and drawings herein are merely illustrative, and that various modifications, combinations, and changes can be made in the structures and methods disclosed without departing from the spirit of the invention.

### DETAILED DESCRIPTION OF THE PREFERRED EMBODIMENTS

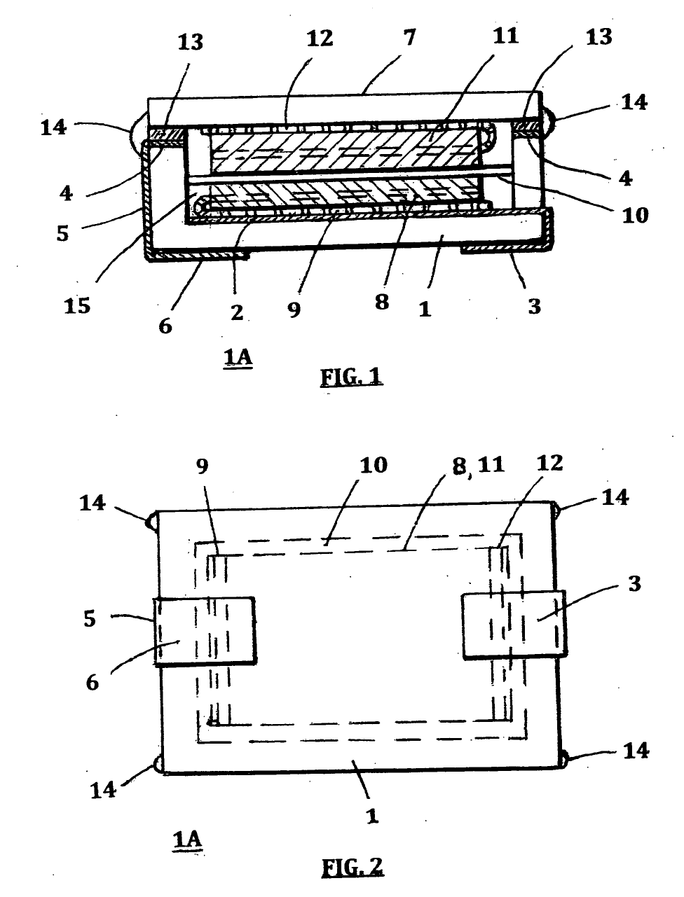

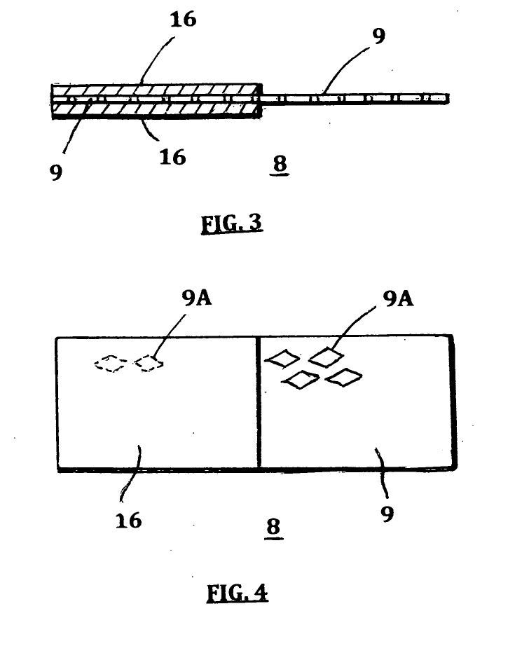

When referring to the preferred embodiments, certain terminology will be utilized for the sake of clarity. Use of such terminology is intended to encompass not only the described embodiments, but also technical equivalents, which operate and function in substantially the same way to bring about the same result. Referring now in more detail and particularly to FIGS. 1 and 2, which is one embodiment of the invention, showing cross-sectional and bottom view of a non-aqueous, high temperature cell 1A like ultracapacitor, asymmetric ultracapacitor, or lithium ion cell, which comprises:

Preferably electrically insulating ceramic, glass, or high temperature resistant polymer, square pan shaped housing 1, with metalized, preferably aluminum inside bottom layer 2, electrically connected to metalized positive terminal 3, on the outside bottom of the pan housing 1; metalized rim 4, all around the top of the housing 1; metalized connector 5, connecting the rim 4 with metalized negative terminal 6 on the outside bottom of the pan housing 1; preferably nickel metal lid 7, connected all round to the rim 4 by epoxy adhesive for metals hermetic seal 13, and by laser metal tack-weld beads 14 at several places of the lid 7; high temperature resistant positive electrode 8 with preferably aluminum micro-grid long tab 9, resistance welded to the layer 2 and folded between the electrode 8 and the layer 2; high temperature resistant electrically insulating porous separator 10; high temperature resistant negative electrode 11 with preferably aluminum or copper micro-grid long tab 12, resistance welded to the lid 7, and folded on the top of the electrode 11, and high temperature resistant electrolyte 15 soaked into the cell's electrodes 8 and 11 and separator 10, before closing and hermetically sealing the lid 7 in an inert dry atmosphere. Because the electrodes 8 and 11 are porous, due to their micro-grids 9 and 12 presence, as well as the separator 10 is porous, the whole cell inside of the housing 1 is porous, and thus can be activated by the liquid electrolyte 15. Because the electrolyte 15 contains high boiling solvents (240° C. boiling point) and high temperature salts, which withstand a higher temperature than melting point of solder, the described cell can be used with a wave soldering process, and melting the solder joints at the terminals 3 and 6 in an oven. It should be noted that the separator 10 is larger than the electrodes 8 and 11 active surfaces to prevent short-circuiting. The separator should have the same footprint as the inside of the bottom surface of the pan housing 1. High temperature porous separator 10 can be of porous Teflon, polyamide non-woven or glass non-woven materials. It is self-evident that the resistance or ultrasound welding of the tabs 9 and 12 to the metalized layer 2 and to the lid 7 provides for a superior conducting, i.e., low impedance, as compared to the wet contact of the electrodes with collectors, in the prior art.

Preferred ceramic for the housing 1 is alumina. The pan housing 1 and the lid 7 are not limited to have just square footprint, but may have also rectangular, round, or oval footprint. Preferred high temperature electrolyte solvents for ultracapacitors may be PC (propylene carbonate), and for lithium ion cells may be EC (ethylene carbonate), and PC mixture (240° C. boiling point). Preferred salt in the ultracapacitors electrolyte is TEMABF₄. Preferred salt in the lithium ion cell electrolyte is LiBF₄. Preferred metalizing metals are aluminum inside, and nickel, silver and gold on the outside surfaces. Using the epoxy seal 13 between the rim 4 and the lid 7 is much easier than brazing, and then the metal laser welding of “bridge” beads 14 in the air is also easier, and conduct electrically over the epoxy in several places, and prevent any delamination of the lid 7.

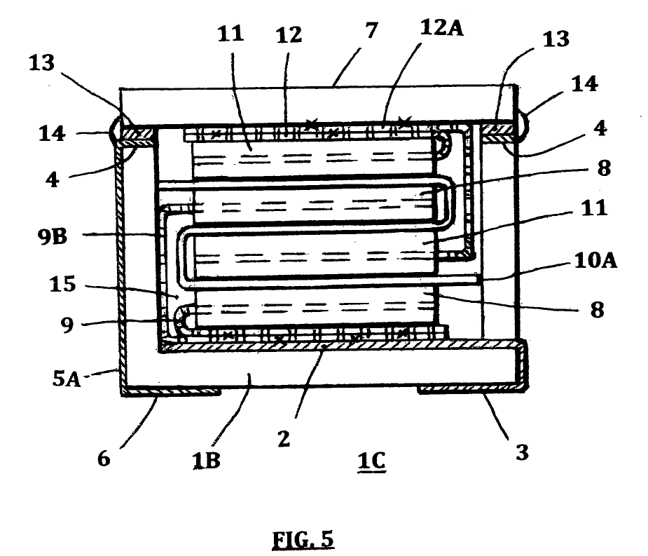

Referring now to FIGS. 3 and 4, which is another embodiment of the invention, showing typical ultmcapacitor dry electrode 8 of the cell described above. The electrode material 16 is coated on both sides of a pre-treated aluminum or copper micro-grid collector 9 by an environmentally friendly process, in the air (=easier and cheaper). The coating slurry contains water as a solvent, gelling agent, active material, high surface carbon black and a water soluble binder. Method of the coating may be dip-coating of the grids, or slot coating, or doctor blade coating of the grids with a solid film support. The water is evaporated and the coating is thus solidified. The coating does not contain electrolyte. The micro-grids may be also coated only on one side, preferably facing the separator (not shown).

The pre-treatment of the aluminum grid is a dry thin coat on the grid surface, based on Polaqua acrylic, water based polymer mixed with high surface carbon. This treatment protects the grid from corrosion and improves contact conductivity and adhesion of the active material 16 with the collector 9. The electrode has a long tab 9, which is a continuation of the collector 9. The direction of diamond shaped grid holes 9A is shown.

In lithium-ion cells, the copper grid is similarly coated with a negative material such as graphite, and copper grid is pretreated with a thin coat of polyvinyldiene fluoride homopolymer plus carbon in acetone and NMP, and baked at 240 C. Pretreated aluminum grid is coated with a positive material, such as a lithiated metal oxide. For both active materials, the solvent, carbon and the binder is the same as above for ultracapacitor cells. In both types of the cells, the electrodes and the separator are vacuum dried before activation with the heat resistant electrolyte 15.

Referring now to FIG. 5, which is another embodiment of the invention, showing cross sectional view of a non-aqueous, high temperature multi cell assembly 1C, which comprises:

Preferably ceramic square pan shaped housing 1B, with preferably metalized aluminum inside bottom layer 2 electrically connected to metalized positive terminal 3, on the outside bottom of the pan housing; metalized rim 4 all around on the top of the pan housing 1B; metalized connector 5A, connecting the rim 4 with metalized negative terminal 6; preferably nickel metal lid 7, connected to the all around metalized rim 4 by epoxy adhesive seal 13 and by laser metal weld beads 14 at several places of the lid 7; two positive electrodes 8 with preferably aluminum micro-grid long tabs 9 and 9B, resistance welded to the layer 2 and folded; high temperature resistant, electrically insulating, porous separator 10A; two negative electrodes 11 with preferably aluminum micro-grids long tab 12 and 12A, resistance welded to the lid 7 and folded; and the high temperature resistant electrolyte 15, soaked into the electrodes 8 and 11 and separator 10A, before closing and sealing the lid 7, in an inert atmosphere. Because the electrodes 8 and 11 and separator 10A are porous, the whole stack of cells inside of the housing 1A is porous, and thus can be activated by the liquid electrolyte 15. The advantage of this design over the prior art is in its ability to stack more than one cell into the housing 1B, due to having long tabs on the electrodes 8 and 11, which prior art does not have. Having more cells connected in parallel increases capacity and maintains high rate capability over one thicker cell of prior art. The long separator 10A is preferably “Z” folded between the electrodes as shown, to prevent short circuiting. All other features and materials described above for the cell 1A remains the same for this multi cell 1C. The multi cell 1C is also vacuum dried before the activation with electrolyte 15, and closing and sealing the lid 7.

The described electrochemical cells can withstand not only the described high temperatures of soldering, but also can operate in these temperatures, up to 235 C.

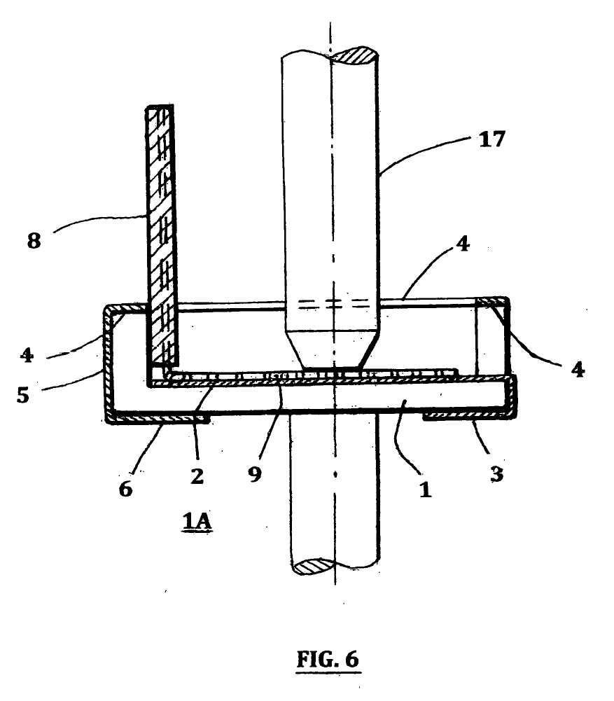

Referring now to FIG. 6, which is another embodiment of the invention, showing method of assembly of the positive electrode 8 in cross-sectional side view of the high temperature resistant cell 1A, when the cell is open and partially assembled, and having the positive electrode's tab 9 resistance or ultrasound welded to the inner bottom horizontal layer 2. The electrode 8 is positioned 90 degrees to the layer 2 and the tab 9 by bending the tab 9 to provide a space for the resistance or ultrasound welder rod 17. After the welding, the electrode 8 is folded on top of the tab 9, as shown in the FIG. 1, and the separator 10 is added.

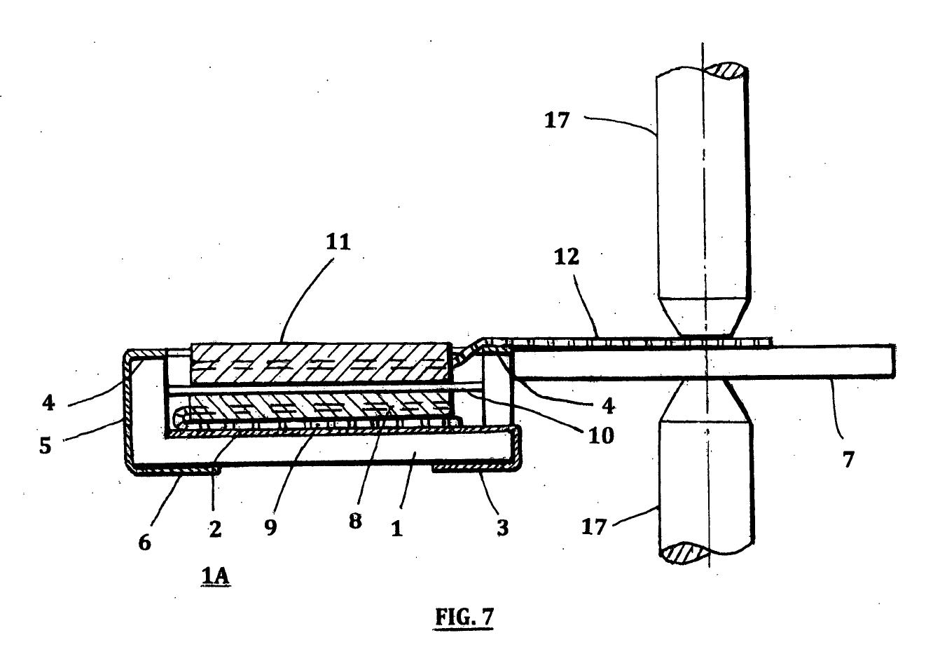

Referring now to FIG. 7, which is another embodiment of the invention, showing another method of assembly of the negative electrode 11 in a cross-sectional side view of the high temperature cell 1A, when the cell is open and the negative electrode tab 12 is resistance or ultrasound welded to the inner side of the lid 7. The electrode 11 is inserted into the cell on top of the separator 10, is clamped (not shown), and its long tab is left protruding out of the cell housing 1.

The lid 7 is inserted under the tab12 and the tab 12 is resistance welded to the lid 7. Then the tab 12 with the lid 7 is bent 90 degrees upward or more, and this still open cell 1A is vacuum dried for several hours in a vacuum chamber. After drying, the cell is activated by metered electrolyte 15 from a syringe in an inert dry atmosphere glove box, the clamp is removed and the lid 7 is sealed and adhesively attached to the rim 4 by the high temperature resistant adhesive like epoxy13. After the adhesive 13 is solidified, the cell is removed from the glove box and the lid 7 is additionally secured in the by the electro-conductive laser metal tack-weld beads 14 to the rim 4, as shown in FIG. 1 and described above. Preferred laser welding metals are nickel, nickel alloys and gold, in the form of a thin rod.

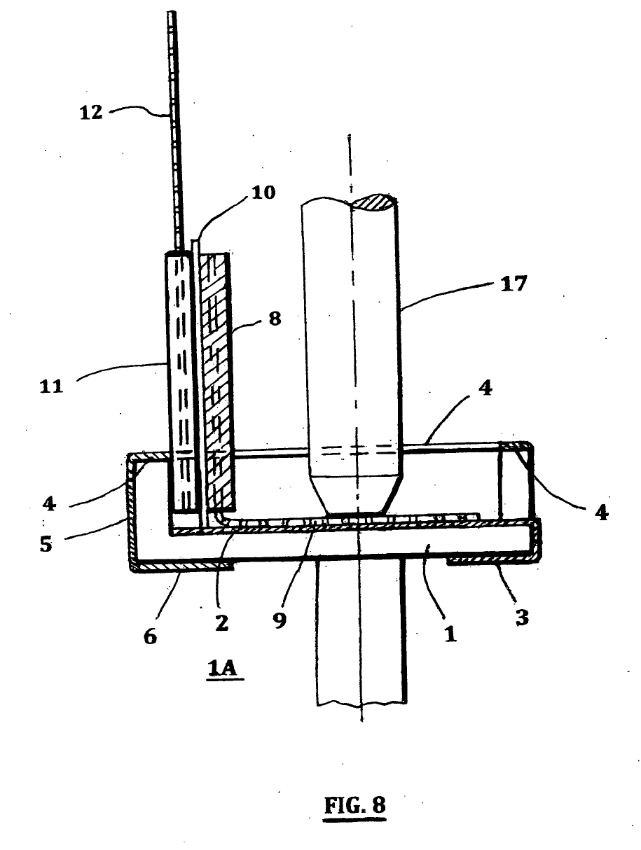

An optional method of assembly of the cell lA comprises having the positive electrode 8 with tap 9; the separator 10; and the negative electrode 11 with tab 12 preassembled (stacked) and clamped together by a clamp (not shown), and the positive electrode tab 9 is bent approximately 90 degrees and is similarly welded to the bottom inside layer 2, as shown in FIG. 8, which is another embodiment of the invention. The cell is then folded at the tab 9 on top of the positive electrode tab 9, as shown in FIG. 1. Then the lid 7 is similarly welded to the negative electrode tab 12, as shown in FIG. 7, and folded as shown in FIG. 1.

It should be noted, that the method of assembly of the multi cell 1C is substantially similar as is described for the single cell 1A, except that two plus two electrodes' tabs are welded to the layer 2 and the lid 7, as shown in FIG. 5. It will thus be seen, that lower cost, easier assembly methods, and highly conductive electrochemical cells for high temperature applications are herein described with which the objects of the invention are achieved.

We claim:

1. Method of assembly of high temperature resistant cell comprising:
providing an insulating, heat resistant, pan shaped housing having a foot print and selectively metalized connectors on inside and outside surfaces connected to one positive and one negative terminals on its bottom surface;
providing a metal lid having the same footprint as said housing footprint;
providing one positive and one negative heat resistant, porous, flat electrodes, having flat metal micro-grid current collectors and flat long micro-grid tabs;
providing a heat resistant, electrically insulating, porous separator;
providing a heat resistant, non-aqueous electrolyte;
providing a heat resistant adhesive for metals;
providing a spring clamp for holding said cell together;
providing a resistance welding unit with electrode size fitting into said housing inside footprint;
providing a laser welding unit with a metal welding rod;
providing a vacuum chamber with a glove box having inert dry atmosphere; and
in air inserting and laying flat said positive electrode tab onto said inside bottom metalized surface of said housing, welding said tab to said metalized surface by said resistance welding unit, and folding said positive electrode on top of said tab;
laying said separator in overlaying manner on top of said positive electrode;
laying flat said negative electrode on top of said separator, aligned with said positive electrode and having said negative electrode tab on the opposite side of said positive electrode tab and protruding horizontally outside of said cell housing;
clamping said cell together with said clamp, sliding said metal lid under said negative electrode tab in aligned manner, and resistance welding said tab to said lid by said resistance welding unit, and folding said negative electrode tab with said lid on top of said negative electrode and said clamp;
placing said cell assembly into said vacuum chamber and drying said cell several hours under vacuum, then placing said cell into said glove box with inert dry atmosphere and activating said cell with said electrolyte, under said atmosphere;
removing said clamp and jointing and sealing said lid to said housing by said heat resistant adhesive;
solidifying said adhesive;
removing said enclosed cell from said glove box into air, and metal spot-welding said lid to said housing's metalized surface in several places by said laser welding unit with said metal rod.

2. Method of assembly of high temperature resistant cell comprising:
providing an insulating, heat resistant, pan shaped housing having a foot print and selectively metalized connectors on inside and outside surfaces connected to one positive and one negative terminals on its bottom surface;
providing a metal lid having the same footprint as said housing footprint;
providing one positive and one negative heat resistant, porous, flat electrodes, having flat metal micro-grid current collectors and flat long micro-grid tabs;
providing a heat resistant, electrically insulating, porous separator;
providing a heat resistant, non-aqueous electrolyte;
providing a heat resistant adhesive for metals;
providing a spring clamp for holding said cell together;
providing a resistance welding unit with electrode size fitting into said housing inside footprint;
providing a laser welding unit with a metal welding rod;
providing a vacuum chamber with a glove box having inert dry atmosphere; and
in air stacking said positive electrode with said tab, said separator, and said negative electrode with said tab in aligned manner, so that said positive electrode having said negative electrode tab on the opposite side of said positive electrode tab;
in air inserting and laying flat said positive electrode tab onto said inside bottom metalized surface of said housing, welding said tab to said metalized surface by said resistance welding unit, and folding said positive electrode with said stocked separator and said negative electrode on top of said tab, and having said negative electrode tab protruding horizontally outside of said housing;
clamping said cell together with said clamp, sliding said metal lid under said negative electrode tab in aligned manner, and resistance welding said tab to said lid by said resistance welding unit, and folding said negative electrode tab with said lid on top of said negative electrode and said clamp;
placing said cell assembly into said vacuum chamber and drying said cell several hours under vacuum, then placing said cell into said glove box with inert dry atmosphere and activating said cell with said electrolyte, under said atmosphere;
removing said clamp and jointing and sealing said lid to said housing by said heat resistant adhesive;
solidifying said adhesive;
removing said enclosed cell from said glove box into air and metal spot-welding said lid to said housing's metalized surface in several places by said laser welding unit with said metal rod.

3. Method of assembly of high temperature resistant cell as described in claim 1, in which said electrodes are coated by dip coating method in air.

4. Method of assembly of high temperature resistant cell as described in claim 1, in which said electrodes are coated by slot coating method in air, with a solid film support of said micro-grids.

5. Method of assembly of high temperature resistant cell as described in claim 1, in which said electrodes are coated by doctor blade coating method in air, with a solid film support of said micro-grids.

6. Method of assembly of high temperature resistant cell as described in claim 1, in which said heat resistant adhesive is epoxy.

7. Method of assembly of high temperature resistant cell as described in claim 1, in which said electrodes' tabs are resistance welded in air to said housing's metalized inner surface and to said lid, while said positive electrode and said negative electrode tab are on the outside of said housing.

8. Method of assembly of high temperature resistant cell as described in claim 1, in which said laser spot-welding metal is selected from the group comprising nickel, nickel alloy and gold.

9. Method of assembly of high temperature resistant cell as described in claim 1, in which said resistance welding unit and said resistance welding is replaced by ultrasound welding unit and ultrasound welding.

10. Method of assembly of high temperature resistant cell as described in claim 2, in which said electrodes are coated by dip coating method in air.

11. Method of assembly of high temperature resistant cell as described in claim 2, in which said electrodes are coated by slot coating method in air, with a solid film support of said micro-grids.

12. Method of assembly of high temperature resistant cell as described in claim 2, in which said electrodes are coated by doctor blade coating method in air, with a solid film support of said micro-grids.

13. Method of assembly of high temperature resistant cell as described in claim 2, in which said heat resistant adhesive is epoxy.

14. Method of assembly of high temperature resistant cell as described in claim 2, in which said electrodes' tabs are resistance welded in air to said housing's metalized inner surface and to said lid, while said positive electrode, said separator, said negative electrode and said negative electrode tab are on the outside of said housing.

15. Method of assembly of high temperature resistant cell as described in claim 2, in which said laser spot-welding metal is selected from the group comprising nickel, nickel alloy and gold.

16. Method of assembly of high temperature resistant cell as described in claim 2, in which said resistance welding unit and said resistance welding is replaced by ultrasound welding unit and ultrasound welding.
